(19) United States
(12) Patent Application Publication
(10) Pub. No.: US 2004/0185778 A1
(43) Pub. Date: Sep. 23, 2004

(54) Peripheral communication

(76) Inventors: Marc C. Biundo, Vancouver, WA (US); Jeremy Bunn, Kelso, WA (US); Loren Chapple, Vancouver, WA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/392,562

(22) Filed: Mar. 20, 2003

(51) Int. Cl. H04M 1/00; H04B 1/38

(52) U.S. Cl. 455/41.2; 455/41.3; 455/557

(57) ABSTRACT

A system for sending a service request to a single peripheral among multiple peripherals includes a first communication link for identifying the multiple peripherals, and over which the service request will be sent to the single peripheral. The system also includes a second communication link for identifying the single peripheral, wherein the range of the second communication link is less than the range of the first communication link.

Networked electronic devices are increasingly prevalent in today's society. Many of these electronic devices are portable electronic devices, such as cellular phones, personal digital assistants (PDA's), laptops, tablet computer, digital cameras, and digital video recorders to name a few. It may be desirable for an electronic device to send digital information to a peripheral, for example an imaging mechanism, a vending machine, an automatic teller machine (ATM), a door lock, a television, a computer, or even a cash register. In order for an electronic device to share digital information with a peripheral, it has often been necessary to save the digital information to a storage media and physically transport that storage media to a media reader coupled to the peripheral, or it has meant directly coupling the electronic device to the peripheral via a docking cradle or communications cable.

More recently, data from electronic devices can be passed to peripherals using infrared (IR) signals or radio frequency (RF) signals, without the need for removing a storage media, docking the electronic device in a cradle, or plugging a cable into the electronic device. Unfortunately, IR signals are limited in their range, and IR transceivers on both the electronic device and the peripheral must be in a fairly narrow alignment for communication to occur. Additionally, IR communications are often limited by data rates, leading more and more electronic devices and peripherals to incorporate RF communications instead.

Electronic devices which employ RF signals for communication, such as those which utilize the 802.11 or Bluetooth protocols can also communicate without the need for removing a storage media, docking the electronic device in a cradle, or plugging a cable into the electronic device. Unlike IR communications, RF communications and protocols allow discovery of unknown or out-of sight peripheral in a given area. For example, a peripheral can be internally or externally coupled to an RF transceiver which is suitably configured to understand a particular communications protocol, such as Bluetooth. Digital data may be sent to the peripheral over the RF channel. The peripheral typically broadcasts an identifying name. If an RF-equipped electronic device is brought within the transmission area of the peripheral, the electronic device may register the availability of the RF-equipped peripheral. The user can then reliably send data to the peripheral over the RF link at suitably high speeds.

Unfortunately, with the prevalence of RF enabled electronic devices and peripherals, a given electronic device may easily become saturated with too many peripherals to send data too. For example, an office may have several to hundreds of imaging mechanisms which are RF-enabled, broadcasting, and waiting for an electronic device to send data to them. An RF-enabled electronic device might see all or an unmanageable number of imaging mechanism choices. A user can not be expected to know which of the available imaging mechanisms are located near to him.

Therefore, it would be desirable to have a system, method, and apparatus allowing an electronic device to easily identify a nearby peripheral among several similar choices presented to it in an RF-networked area.

### BRIEF DESCRIPTION OF THE DRAWINGS

FIG. 1 schematically illustrates one embodiment of an electronic device in communication with a plurality of peripheral devices.

FIG. 2 illustrates one embodiment of actions for an electronic device to communicate with a single peripheral among multiple peripherals.

FIG. 3 illustrates embodiments of actions which a PDA might take to print a document on a printer when employing the systems and methods of FIGS. 1-2.

FIG. 4 schematically illustrates one embodiment of an electronic device in communication with a plurality of peripheral devices.

FIG. 5 illustrates one embodiment of actions for an electronic device to communicate with a single peripheral among multiple peripherals.

FIG. 6 schematically illustrates one embodiment of an electronic device in communication with a plurality of peripheral devices.

FIG. 7 illustrates one embodiment of actions for an electronic device to communicate with a single peripheral among multiple peripherals.

FIG. 8 schematically illustrates one embodiment of an electronic device in communication with a plurality of peripherals.

FIG. 9 illustrates one embodiment of actions for an electronic device to communicate with a single peripheral among multiple peripherals.

FIGS. 10A-10B schematically illustrate embodiments of peripherals.

FIGS. 11-11B schematically illustrate embodiments of electronic

FIGS. 12-13 illustrate embodiments of actions which may be used to communication conflicts between a plurality of peripherals.

FIG. 14 illustrates one embodiment of actions which may be used to communicate with a local peripheral among multiple peripherals.

### DETAILED DESCRIPTION OF THE PREFERRED EMBODIMENTS

Electronic devices are increasingly equipped with communication links which move the necessity for tethering the devices to peripherals which they are able to share data with. Electronic devices may include personal digital assistants (PDA's), laptops, digital cameras, digital video recorders, wrist watches, automobiles, and cellular phones, to name a few. Peripherals equipped with a compatible communication link may receive data from an electronic device for the purpose of performing a service for the electronic device. Peripherals may include imaging mechanisms such as inkjet printers, liquid and dry-based electrophotographic printers, dye sublimation printers, televisions, liquid crystal displays (LCD's), and video projectors. These imaging mechanism peripherals may provide services such as generating hard copy output; rendering; displaying images; storing images; and retrieving remote images, documents, or files from a storage location as requested by the electronic device. Peripherals may also include vending machines, wireless network access points, gas station pumps, automatic teller machines (ATM's), cash registers, payment locations, or even door locks. These peripherals may provide services such as financial exchanges, security authorizations, and purchases. Peripherals may also include the previously listed electronic devices, provided the peripheral electronic device was providing a service for another electronic device. Other peripherals and electronic devices will be self evident and are intended to be covered and included under this specification and the appended claims.

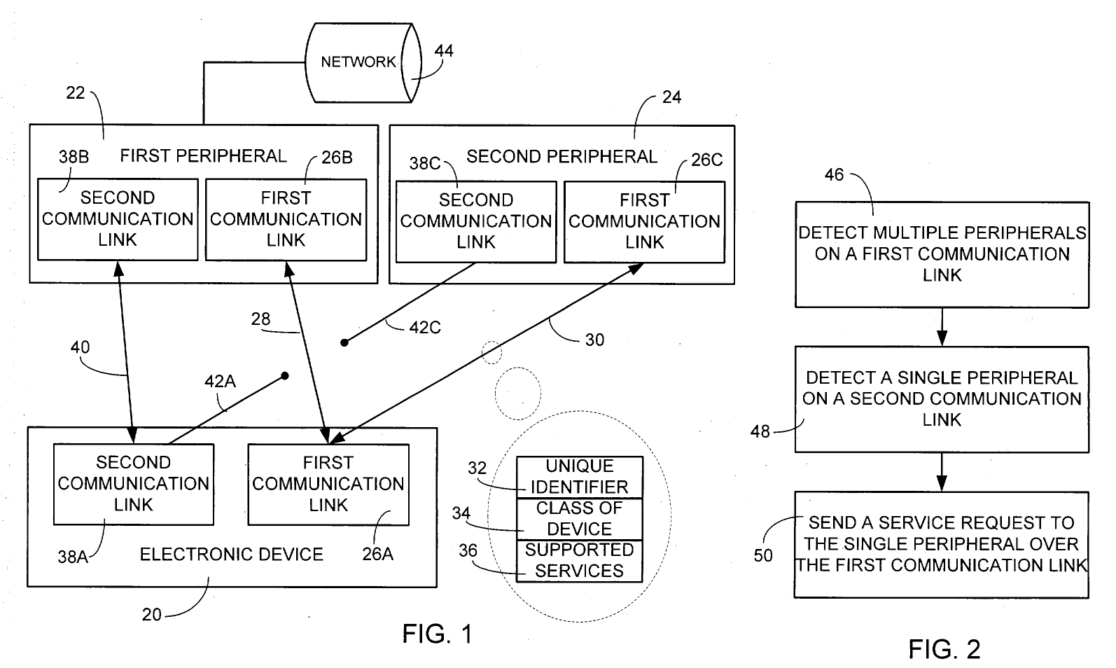

FIG. 1 schematically illustrates one embodiment of an electronic device 20 in communication with a plurality of peripherals 22, 24. The electronic device 20 has a first communication link 26A. This first communication link 26A is a wireless communication link, such as a radio frequency (RF) communication link. An example RF communication link would be one implementing the IEEE 802.11 wireless protocols or the Bluetooth wireless protocol. The first communication link 26A is able to transmit and receive signals over a wide area. Current RF transmissions are able to cover a range of several hundred feet or more.

The peripherals 22, 24 embodied in FIG. 1 have a first communication link 26B and 26C, respectively. Although only two peripherals 22, 24 are illustrated in the embodiment of FIG. 1, it should be understood that the concepts described herein, and their equivalents, are applicable to any plurality of peripherals. For sake of explanation, only the two peripherals 22, 24 will be used. Given the wide range of the first communication links 26A, 26B, 26C, the electronic device 20 may establish a connection 28 with the first peripheral 22 as well as a connection 30 with the second peripheral 24. Typically, such connections 28, 30 amount to an awareness by the electronic device 20 that the connected peripherals 22, 24 are present in communication range. Some basic information about the peripherals 22, 24 may also be communicated to the electronic device 20, such as a unique identifier 32, a class of device 34, and a supported services list 36. Examples of a unique identifier 32 could include a MAC address or Bluetooth address which are known to those skilled in the art. Such unique identifiers 32 are like unique serial numbers the manufacturing community agrees to assign each peripheral 22, 24 it produces, thereby enabling them to be differentiated. The class of device 34 is a code that can be used to identify what general type of peripheral the electronic device 20 is communicating with. For example, the class of device 34 might indicate that a peripheral is a printer, a vending machine, or an image projector. The supported services list 36 may contain codes describing the capabilities of the peripheral type indicated by the class of device 34. For example, if the class of device 34 indicated the peripheral 24 was a multi-function printer, then the supported services list 36 might include a) printing, b) scanning, and c) faxing to name a few.

With the increasing proliferation of electronic devices 20 and peripherals 22, 24 having wide-area wireless communication capability, such as the first communication link 26A, 26B, 26C illustrated in FIG. 1, it becomes more likely that an electronic device 20, needing the services of a single peripheral, will be presented with a plurality of choices of peripherals 22, 24 in the desired class of device 34. For example, in a heavily populated office, the list of available printers for the user of a PDA could be overwhelming. The information provided over the first communication link 26A would not be sufficient to determine which of the printers in a list of available printers was the one a user wanted to select, for example a particular printer that the PDA was nearest-to.

The electronic device 20 and the peripherals 22, 24, illustrated in the embodiment of FIG. 1, each have a second communication link 38A, 38B, and 38C, respectively. The nature of the second communication link 38A, 38B, 38C is such that it has a range which is more limited than the first communication link 26A, 26B, 26C. The shortened range of the second communication link 38A, 38B, 38C allows the electronic device 20 to make a localized connection 40 to a first peripheral 22, while avoiding a connection with other peripherals 24 that are out of the range 42A, 42C of the second communication links 38A, 38C.

The localized connection 40 amounts to an awareness by the electronic device 20 that the connected peripheral 22 is a nearby peripheral present in communication range. While the localized connection 40 may supply many pieces of information to the electronic device 20 about the peripheral 22, such as a unique identifier 32, a class of device 34, and a supported services list 36, the unique identifier 32 is all that may be necessary. Once the electronic device receives the unique identifier 32 of the peripheral 22 over the localized connection 40, the electronic device 20 can cross-reference this unique identifier 32 with the plurality of peripherals 22, 24 available over the first communication link 26A, 26B, 26C to identify the peripheral 22 which is nearest. Data can then be sent over the first communication link 26A, 26B, via the connection 28, from the electronic device 20 to the first peripheral 22 without a user of the electronic device 20 having to sort through a possibly overwhelming, confusing, or unfamiliar number of choices in selecting a desired peripheral.

The embodiment of FIG. 1 also illustrates that the peripheral 22 may be connected to a network 44, such as a local area network (LAN), an intranet, or the internet. A peripheral 22 which is connected to a network 44 may be able to provide additional services for electronic devices 20 which link to it. These services may include, for example, remote data retrieval, remote data storage, or remote rendering. While the embodiments illustrated herein may show peripherals connected to a network 44, it should be understood that a network 44 connection is not a requirement for a peripheral 22, 24 to have.

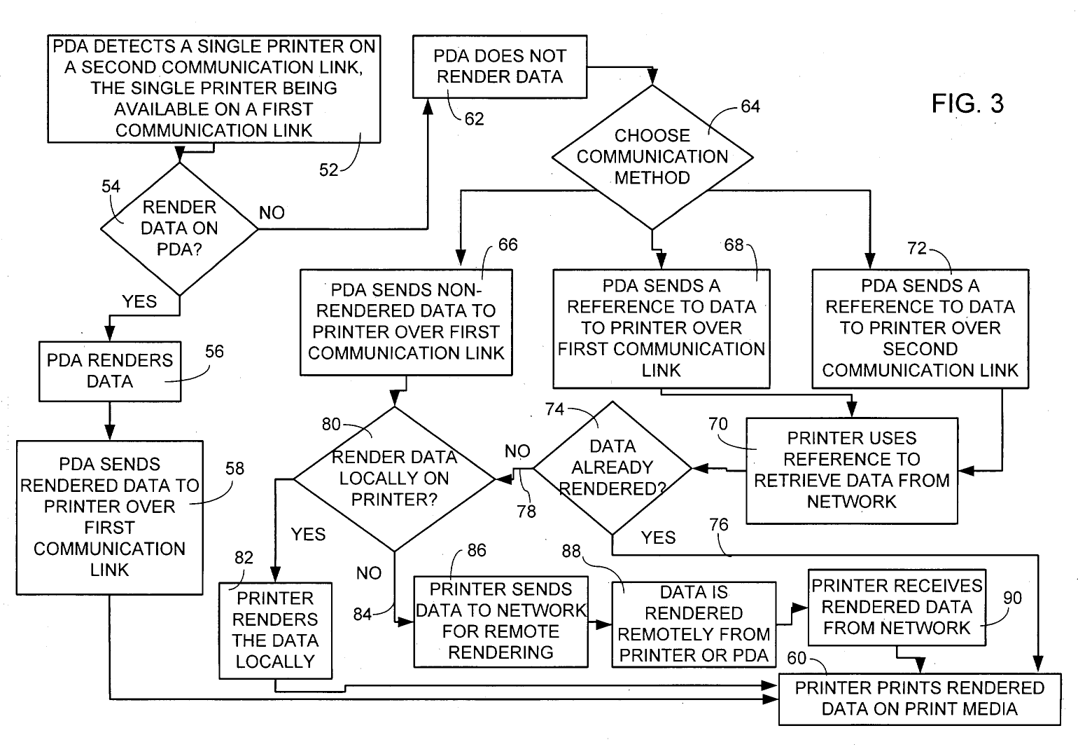

FIG. 2 illustrates one embodiment of actions for an electronic device 20 to communicate with a single peripheral among multiple peripherals. The electronic device 20 may detect 46 multiple peripherals on a first communication link. The electronic device 20 may also detect 48 a single peripheral on a second communication link. The electronic device 20 may then send 50 a service request to the single peripheral over the first communication link. A service request can vary depending on the type of peripheral being communicated with (class of device 34) and may also vary depending on the supported services 36 of the peripheral. For example, if the electronic device 20 were a PDA, and if the single peripheral were an imaging mechanism, such as a printer, the PDA may request services that allow documents to be printed. This might occur in several ways, as illustrated by the embodiments of FIG. 3.

FIG. 3 illustrates embodiments of actions which a PDA might take to print a document on a printer when employing the systems and methods of FIGS. 1-2. The actions of FIG. 3 begin when a PDA has detected 52 a single printer on a second communication link, the single printer being available on a first communication link as described above. A decision 54 is made whether to render data on the PDA. Rendering data refers to the process of transforming the document data into a format which can be used by the printer to generate a hardcopy print of the document on a print media. If the PDA renders 56 the data, the PDA will then send 58 the rendered data to the printer over the first communication link. The printer may then print 60 the rendered data on a print media. If the PDA does not render 62 the data, then a communication method must be chosen 64. As a first option, the PDA may send 66 the non-rendered data to the printer over the first communication link. As a second option, the PDA may send 68 a reference to the data over the first communication link to the printer. The printer may then use the reference to retrieve 70 the data from the network which was referred-to by the reference. As a third option, the PDA may send 72 a reference to the data over the second communication link to the printer. While the potentially higher transmission rates and/or convenience of the first communication link may be more desirable when sending large amounts of data, the second communication link may be acceptable and even more convenient when sending only a reference to data to the printer. Whether the PDA sends the reference to data over the first communication link 68 or over the second communication link 72, after the printer has retrieved the data from the reference over the network, a decision 74 may be made as to whether the retrieved data has already been rendered. If the retrieved data is already rendered 76, then the printer can print 60 the rendered data on a print media. If the retrieved data is not rendered 78, then a decision 80 may be made whether or not to render the data locally on the printer. The decision may be made to render 82 the data locally, after which the printer may print 60 the rendered data on a print media. If the data will not be rendered 84 locally on the printer, then the printer may send 86 the non-rendered data to the network for rendering. The data is then rendered remotely 88 from the printer or the PDA. The printer receives 90 the rendered data back from the network, and then the printer may print 60 the rendered data on a print media. If the PDA had chosen to send 66 non-rendered data directly over the first communication link, then the same decision 80 of whether to render the data locally on the printer could eventually lead to printing 60 rendered data onto a print media as already described following the reference-to-data scenarios.

It should be understood that the embodiment of FIG. 3 is just one example of involving one type of electronic device, one type of peripheral, and one type of service request (generating a hardcopy image). These embodiments are not intended to limit the scope of this disclosure or the claims appended hereto.

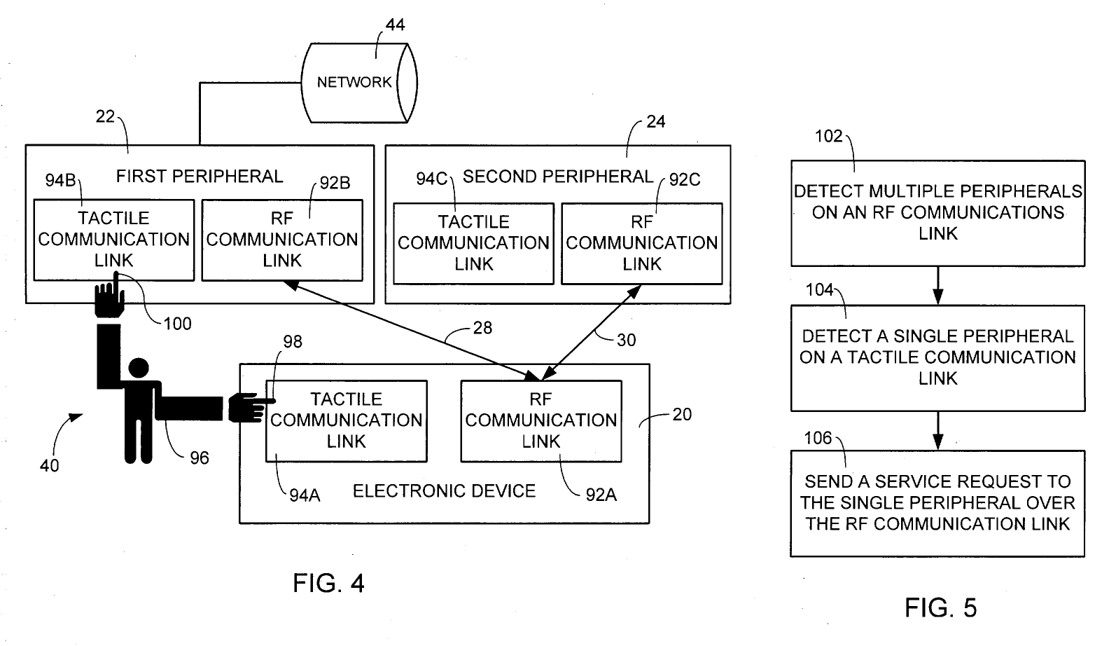

FIG. 4 schematically illustrates one embodiment of an electronic device 20 in communication with a plurality of peripherals 22, 24. The electronic device 20 has a first communication link, here shown as a radio frequency (RF) communication link 92A. This RF communication link 92A is a wireless communication link. An example RF communication link would be one implementing the IEEE 802.11 wireless protocols or the Bluetooth wireless protocol. The RF communication link 92A is able to transmit and receive signals over a wide area. Current RF transmissions are able to cover a range of several hundred feet or more.

The peripherals 22, 24 embodied in FIG. 4 have an RF communication link 92B and 92C, respectively. Although only two peripherals 22, 24 are illustrated in the embodiment of FIG. 4, it should be understood that the concepts described herein, and their equivalents, are applicable to any plurality of peripherals. For sake of explanation, only the two peripherals 22, 24 will be used. Given the wide range of the RF communication links 92A, 92B, 92C, the electronic device 20 may establish a connection 28 with the first peripheral 22 as well as a connection 30 with the second peripheral 24. Typically, such connections 28, 30 amount to an awareness by the electronic device 20 that the connected peripherals 22, 24 are present in communication range. As previously described, with regard to FIG. 1, some basic information about the peripherals 22, 24 may also be communicated to the electronic device 20, such as a unique identifier 32, a class of device 34, and a supported services list 36.

With the increasing proliferation of electronic devices 20 and peripherals 22, 24 having wide-area wireless communication capability, such as the RF communication link 92A, 92B, 92C illustrated in FIG. 4, it becomes more likely that an electronic device 20, needing the services of a single peripheral, will be presented with a plurality of choices of peripherals 22, 24 in the desired class of device 34. For example, in a heavily populated office, the list of available printers for the user of a PDA could be overwhelming. The information provided over the RF communication link 92A would not be sufficient to determine which of the printers in a list of available printers was the one a user wanted to select, for example a particular printer that the PDA was nearest-to.

The electronic device 20 and the peripherals 22, 24, illustrated in the embodiment of FIG. 4, each have a second communication link, here illustrated as a tactile communication link 94A, 94B, and 94C, respectively. The nature of the tactile communication link 94A, 94B, 94C is such that it has a range which is more limited than the RF communication link 92A, 92B, 92C. The range of a given tactile communication link 94A, 94B, 94C is determined by a person 96 coupled to it. Data signals generated by a given tactile communication link 94A, 94B, 94C may be transferred through or on the surface of the person 96 touching the given tactile link to another tactile link in contact with the person 96. The shortened range of the tactile communication link 94A, 94B, 94C allows the electronic device 20 to make a localized connection 40 to a first peripheral 22, while avoiding a connection with other peripherals 24. For the embodiment of FIG. 4, making a localized connection 40 between the electronic device 20 and the peripheral 22 is accomplished by the person 96 touching 98 the electronic device 20 and touching 100 the peripheral 22 at the same time. The contact time need only be long enough to determine the unique identifier 32 of the peripheral 22.

The localized connection 40 amounts to an awareness by the electronic device 20 that the connected peripheral 22 is a nearby peripheral present in communication range. Once the electronic device receives the unique identifier 32 of the peripheral 22 over the localized connection 40, the electronic device 20 can cross-reference this unique identifier 32 with the plurality of peripherals 22, 24 available over the RF communication link 92A, 92B, 92C to identify the peripheral 22 which is nearest. Data can then be sent over the RF communication link 92A, 92B, via the connection 28, from the electronic device 20 to the first peripheral 22 without a user 96 of the electronic device 20 having to sort through a possibly overwhelming, confusing, or unfamiliar number of choices in selecting a desired peripheral. The embodiment of FIG. 4 also illustrates that the peripheral 22 may be connected to a network 44, as previously discussed with regard to FIG. 1.

FIG. 5 illustrates one embodiment of actions for an electronic device 20 to communicate with a single peripheral among multiple peripherals. The electronic device 20 may detect 102 multiple peripherals on an RF communication link. The electronic device 20 may also detect 104 a single peripheral on a tactile communication link. The electronic device 20 may then send 106 a service request to the single peripheral over the RF communication link. A service request can vary depending on the type of peripheral being communicated with (class of device 34) and may also vary depending on the supported services 36 of the peripheral, as previously discussed with regard to FIGS. 2 and 3.

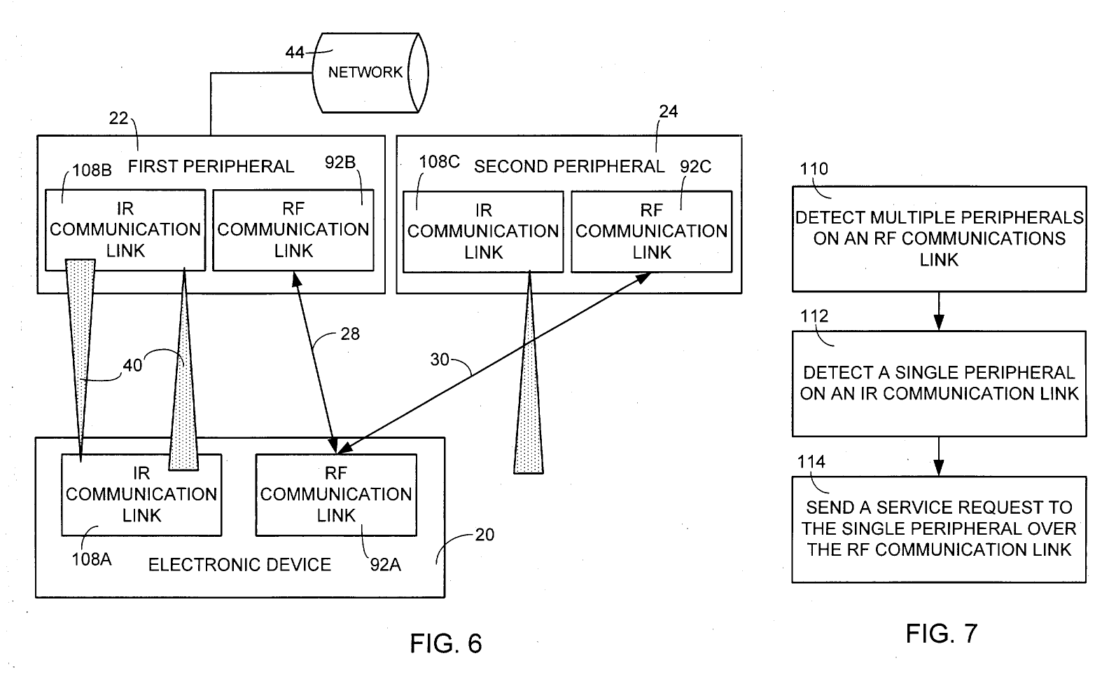

FIG. 6 schematically illustrates one embodiment of an electronic device 20 in communication with a plurality of peripheral devices 22, 24. The electronic device 20 has a first communication link, here shown as a radio frequency (RF) communication link 92A. The peripherals 22, 24 also have an RF communication link 92B and 92C, respectively. The RF communication links 92A, 92B, and 92C have been described previously with regard to FIG. 4.

Although only two peripherals 22, 24 are illustrated in the embodiment of FIG. 6, it should be understood that the concepts described herein, and their equivalents, are applicable to any plurality of peripherals. For sake of explanation, only the two peripherals 22, 24 will be used. Given the wide range of the RF communication links 92A, 92B, 92C, the electronic device 20 may establish a connection 28 with the first peripheral 22 as well as a connection 30 with the second peripheral 24. Typically, such connections 28, 30 amount to an awareness by the electronic device 20 that the connected peripherals 22, 24 are present in communication range. As previously described, with regard to FIG. 1, some basic information about the peripherals 22, 24 may also be communicated to the electronic device 20, such as a unique identifier 32, a class of device 34, and a supported services list 36.

With the increasing proliferation of electronic devices 20 and peripherals 22, 24 having wide-area wireless communication capability, such as the RF communication link 92A, 92B, 92C illustrated in FIG. 6, it becomes more likely that an electronic device 20, needing the services of a single peripheral, will be presented with a plurality of choices of peripherals 22, 24 in the desired class of device 34. For example, in a heavily populated office, the list of available printers for the user of a PDA could be overwhelming. The information provided over the RF communication link 92A would not be sufficient to determine which of the printers in a list of available printers was the one a user wanted to select, for example a particular printer that the PDA was nearest-to.

The electronic device 20 and the peripherals 22, 24, illustrated in the embodiment of FIG. 6, each have a second communication link, here illustrated as an infrared (IR) communication link 108A, 108B, and 108C, respectively. The nature of the IR communication link 108A, 108B, 108C is such that it has a range which is more limited than the RF communication link 92A, 92B, 92C. The range of a given IR communication link 108A, 108B, 108C is determined by the beam of infrared light which it may emit. Data signals generated by a given IR communication link 108A, 108B, 108C may be transferred through space between one link and another IR link. The typical range of an IR communication link 108A, 108B, and 108C is about three meters. Furthermore, for two IR communication links to communicate, they must be aligned so that IR light beams emitted from one link fall onto another link. The shortened and directional range of the IR communication link 108A, 108B, 108C allows the electronic device 20 to make a localized connection 40 to a first peripheral 22, while avoiding a connection with other peripherals 24.

The localized connection 40 amounts to an awareness by the electronic device 20 that the connected peripheral 22 is a nearby peripheral present in communication range. Once the electronic device 20 receives the unique identifier 32 of the peripheral 22 over the localized connection 40, the electronic device 20 can cross-reference this unique identifier 32 with the plurality of peripherals 22, 24 available over the RF communication link 92A, 92B, 92C to identify the peripheral 22 which is nearest. Data can then be sent over the RF communication link 92A, 92B, via the connection 28, from the electronic device 20 to the first peripheral 22 without a user of the electronic device 20 having to sort through a possibly overwhelming, confusing, or unfamiliar number of choices in selecting a desired peripheral. The embodiment of FIG. 6 also illustrates that the peripheral 22 may be connected to a network 44, as previously discussed with regard to FIG. 1.

FIG. 7 illustrates one embodiment of actions for an electronic device 20 to communicate with a single peripheral among multiple peripherals. The electronic device 20 may detect 110 multiple peripherals on an RF communication link. The electronic device 20 may also detect 112 a single peripheral on an IR communication link. The electronic device 20 may then send 114 a service request to the single peripheral over the RF communication link. A service request can vary depending on the type of peripheral being communicated with (class of device 34) and may also vary depending on the supported services 36 of the peripheral, as previously discussed with regard to FIGS. 2 and 3.

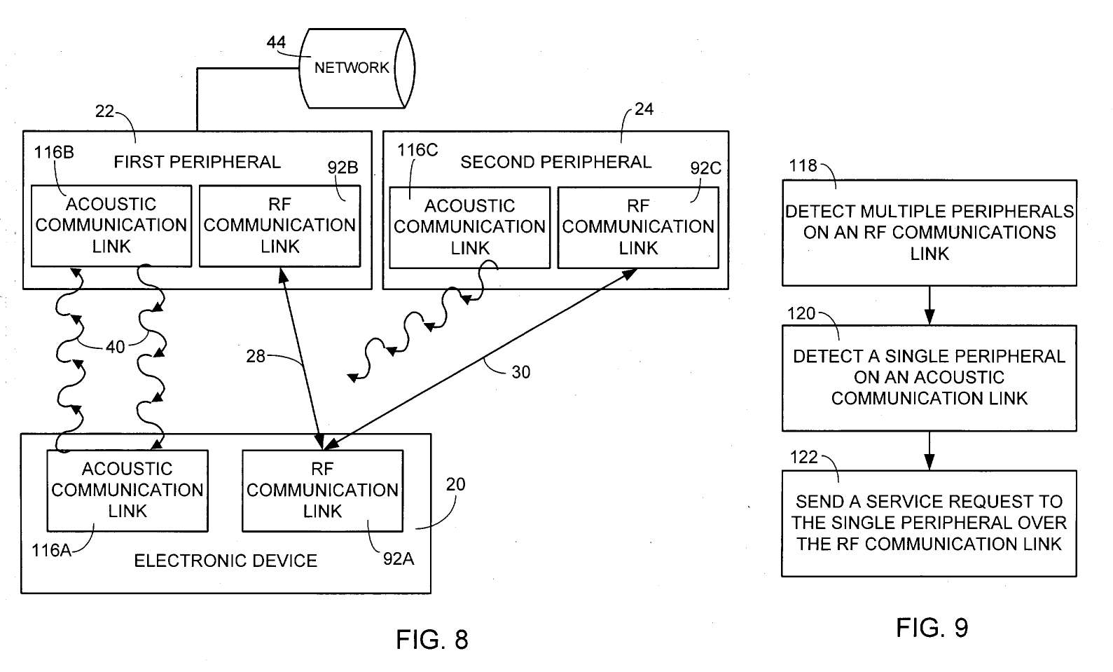

FIG. 8 schematically illustrates one embodiment of an electronic device 20 in communication with a plurality of peripheral devices 22, 24. The electronic device 20 has a first communication link, here shown as a radio frequency (RF) communication link 92A. The peripherals 22, 24 also have an RF communication link 92B and 92C, respectively. The RF communication links 92A, 92B, and 92C have been described previously with regard to FIG. 4.

Although only two peripherals 22, 24 are illustrated in the embodiment of FIG. 8, it should be understood that the concepts described herein, and their equivalents, are applicable to any plurality of peripherals. For sake of explanation, only the two peripherals 22, 24 will be used. Given the wide range of the RF communication links 92A, 92B, 92C, the electronic device 20 may establish a connection 28 with the first peripheral 22 as well as a connection 30 with the second peripheral 24. Typically, such connections 28, 30 amount to an awareness by the electronic device 20 that the connected peripherals 22, 24 are present in communication range. As previously described, with regard to FIG. 1, some basic information about the peripherals 22, 24 may also be communicated to the electronic device 20, such as a unique identifier 32, a class of device 34, and a supported services list 36.

With the increasing proliferation of electronic devices 20 and peripherals 22, 24 having wide-area wireless communication capability, such as the RF communication link 92A, 92B, 92C illustrated in FIG. 8, it becomes more likely that an electronic device 20, needing the services of a single peripheral, will be presented with a plurality of choices of peripherals 22, 24 in the desired class of device 34. For example, in a heavily populated office, the list of available printers for the user of a PDA could be overwhelming. The information provided over the RF communication link 92A would not be sufficient to determine which of the printers in a list of available printers was the one a user wanted to select, for example a particular printer that the PDA was nearest-to.

The electronic device 20 and the peripherals 22, 24, illustrated in the embodiment of FIG. 8, each have a second communication link, here illustrated as an acoustic communication link 116A, 116B, and 116C, respectively. The nature of the acoustic communication link 116A, 116B, 116C is such that it has a range which is more limited than the RF communication link 92A, 92B, 92C. The range of a given acoustic communication link 116A, 116B, 116C is determined by the amplitude and frequency of sound which may be emitted. Data signals generated by a given acoustic communication link 116A, 116B, 116C may be transferred through space between one link and another acoustic link. Data may be acoustically transferred at sub-audible, audible, or super-audible frequencies. While sub-audible frequencies are those lower than humans can normally hear, and super-audible frequencies are those higher than humans can normally hear, the acoustic communication links 116A, 116B, 116C may be designed with a receiving transducer which is able to monitor these frequencies for the purpose of communication. The acoustic communication links 116A, 116B, 116C may also have a sending transducer for generating sound waves. The amplitude of the sent sound waves may be adjusted to have a relatively short range when compared to the RF communication link 92A, 92B, 92C.

The shortened range of the acoustic communication link 116A, 116B, 116C allows the electronic device 20 to make a localized connection 40 to a first peripheral 22, while avoiding a connection with other peripherals 24. The localized connection 40 amounts to an awareness by the electronic device 20 that the connected peripheral 22 is a nearby peripheral present in communication range. Once the electronic device 20 receives the unique identifier 32 of the peripheral 22 over the localized connection 40, the electronic device 20 can cross-reference this unique identifier 32 with the plurality of peripherals 22, 24 available over the RF communication link 92A, 92B, 92C to identify the peripheral 22 which is nearest. Data can then be sent over the RF communication link 92A, 92B, via the connection 28, from the electronic device 20 to the first peripheral 22 without a user of the electronic device 20 having to sort through a possibly overwhelming, confusing, or unfamiliar number of choices in selecting a desired peripheral. The embodiment of FIG. 8 also illustrates that the peripheral 22 may be connected to a network 44, as previously discussed with regard to FIG. 1.

FIG. 9 illustrates one embodiment of actions for an electronic device 20 to communicate with a single peripheral among multiple peripherals. The electronic device 20 may detect 118 multiple peripherals on an RF communication link. The electronic device 20 may also detect 120 a single peripheral on an acoustic communication link. The electronic device 20 may then send 122 a service request to the single peripheral over the RF communication link. A service request can vary depending on the type of peripheral being communicated with (class of device 34) and may also vary depending on the supported services 36 of the peripheral, as previously discussed with regard to FIGS. 2 and 3.

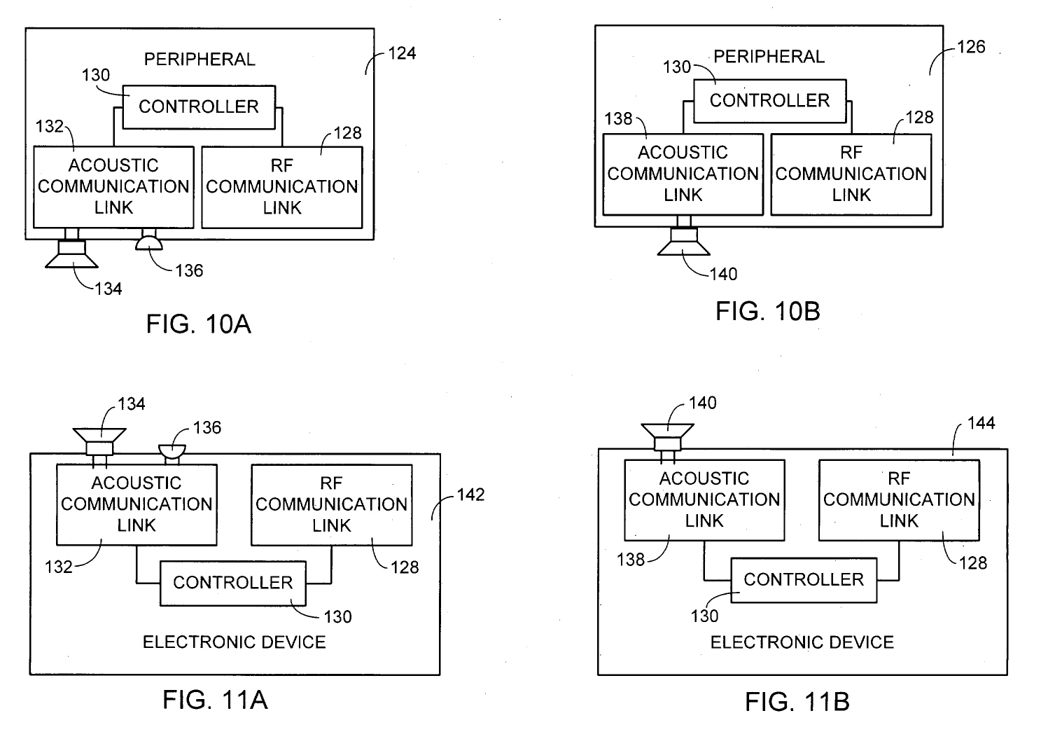

FIGS. 10A and 10B schematically illustrate embodiments of peripherals 124, 126 each having a first communication link, here illustrated as an RF communication link 128, coupled to a controller 130. The peripheral 124 of FIG. 10A has an acoustic communication link 132 which is also coupled to the controller 130. Acoustic communication link 132 has two separate transducers, a sending transducer 134 and a receiving transducer 136. Sending transducer 134 may be an element such as a speaker. Receiving transducer 136 may be an element such as a microphone. The peripheral 124 may be used in the systems illustrated in FIGS. 1 and 8. The RF communication link 128 and the acoustic communication link 132 may be coordinated by the controller 130.

The peripheral 126 of FIG. 10B has an acoustic communication link 138 which is also coupled to the controller 130. The acoustic communication link 138 has one transducer, a sending and receiving transducer 140. Sending and receiving transducer 140 may be an element such as a speaker. The peripheral 126 may be used in the systems illustrated in FIGS. 1 and 8. The RF communication link 128 and the acoustic communication link 138 may be coordinated by the controller 130. Many peripherals already have a transducer which sends 134, 140 as well as a transducer which receives 136, 140 directly or indirectly coupled to a controller 130, so they could be enabled for acoustic communications by suitably programming the controller to monitor-for and emit sub-audible, audible, and/or super-audible communications. A controller 130 may be a computer, a microprocessor, an application specific integrated circuit (ASIC), digital components, analog components, or any combination thereof.

FIGS. 11A and 11B schematically illustrate embodiments of electronic devices 142, 144 each having a first communication link, here illustrated as an RF communication link 128, coupled to a controller 130. The electronic device 142 of FIG. 11A has an acoustic communication link 132 which is also coupled to the controller 130. Acoustic communication link 132 has two separate transducers, a sending transducer 134 and a receiving transducer 136. Sending transducer 134 may be an element such as a speaker. Receiving transducer 136 may be an element such as a microphone. The electronic device 142 may be used in the systems illustrated in FIGS. 1 and 8. The RF communication link 128 and the acoustic communication link 132 may be coordinated by the controller 130.

The electronic device 144 of FIG. 11B has an acoustic communication link 138 which is also coupled to the controller 130. The acoustic communication link 138 has one transducer, here, a sending and receiving transducer 140. Sending and receiving transducer 140 may be an element such as a speaker. The electronic device 144 may be used in the systems illustrated in FIGS. 1 and 8. The RF communication link 128 and the acoustic communication link 138 may be coordinated by the controller 130. Many electronic devices already have a transducer which sends 134, 140 as well as a transducer which receives 136, 140 directly or indirectly coupled to a controller 130, so they could be enabled for acoustic communications by suitably programming the controller to monitor-for and emit sub-audible, audible, and/or super-audible communications.

The embodiment of FIG. 8, illustrates an electronic device 20 which is able to detect a single peripheral 22 on an acoustic communication link 116A, thereby making it possible to isolate that single peripheral 122 from a plurality of peripherals available over an RF communication link 92A, and then send data to the single peripheral over the RF communication link 92A. Due to the potentially non-directional nature of acoustic communications, however, it is possible in certain scenarios that an electronic device 20 could receive acoustic communications from more than one peripheral at the same time. If these peripherals, which are both within acoustic range of the electronic device 20, are transmitting on the same acoustic frequency (same audio or acoustic wavelength), the audio signals of both may interfere with each other, or be garbled as received by the electronic device 20. In order to avoid this situation, it may be desirable for different peripherals within the acoustic range of an electronic device at a particular location to communicate on different audio frequencies.

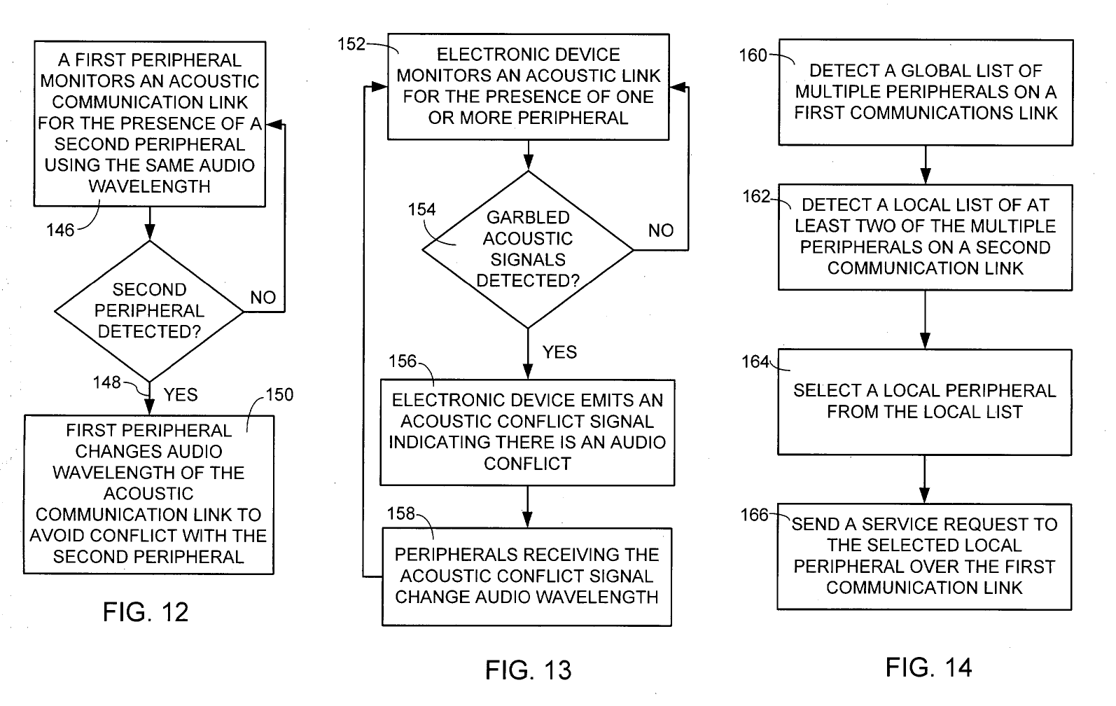

FIG. 12 illustrates one embodiment of-actions which may be used to avoid communication conflicts between a plurality of peripherals. A first peripheral may monitor 146 an acoustic communication link for the presence of a second peripheral using the same acoustic wavelength. If a second peripheral is detected 148 on the same acoustic wavelength, then the first peripheral may change 150 the wavelength of its acoustic communication link to avoid conflict with the second peripheral. The wavelength changes could be made randomly to avoid a situation where two peripherals detect each other and change wavelengths at the same time to the exact same frequency.

The actions of FIG. 12 will not be operable if the peripherals are out of each other's acoustic range. It is conceivable, however, that an electronic device may be within acoustic range of more than one peripheral, while these peripherals are not in acoustic range of each other. Regardless of whether a plurality of peripherals are within each other's acoustic range or not, FIG. 13 illustrates another embodiment of actions which may be used to avoid communication conflicts between a plurality of peripherals. An electronic device monitors 152 an acoustic communication link for the presence of one or more peripherals. If garbled acoustic signals are detected 154, then the electronic device can send 156 an acoustic conflict signal indicating there is an audio wavelength conflict. Peripherals receiving the acoustic conflict signal may then change the audio wavelengths which they are sending at. The wavelength changes could be made randomly to avoid a situation where two peripherals detect each other and change wavelengths at the same time to the exact same frequency.

Once peripherals within acoustic communication range of an electronic device are communicating on separate audio wavelengths, the electronic device may then identify a subset of nearby peripherals from the complete set of peripherals available over a first communication link, such as an RF communication link. FIG. 14 illustrates one embodiment of actions which may be used to communicate with a local peripheral among multiple peripherals. A global list of multiple peripherals may be detected 160 on a first communications link. A local list of one or more of the multiple peripherals is detected 162 on a second communications link. A local peripheral is selected 164 from the local list. While the local list may contain more than one peripheral, it has the potential to contain fewer choices than the global list of peripherals available over the first communication link. Finally, a service request is sent 166 to the selected local peripheral over the first communication link. A service request can vary depending on the type of peripheral being communicated with (class of device 34) and may also vary depending on the supported services 36 of the peripheral. For example, if the electronic device 20 were a PDA, and if the selected peripheral were an imaging mechanism, such as a printer, the PDA may request services that allow documents to be printed.

With the proliferation of electronic devices and peripherals having wireless communication capabilities, in particular the wide reaching and high-speed radio frequency (RF) communication links, such as IEEE 802.11 and Bluetooth, electronic devices have and will continue to have more choices for connectivity. When a person carrying a PDA walks up to a bank of printers in an office of potentially more printers, it would be preferable to be able to transmit data over an RF communication link, while not having to sort through all of the printer choices the RF communication link makes available. Similarly, when a person carrying a cellular phone walks up to a vending machine, it may be preferable to transmit product selection and/or payment information over an RF communication link without having to sort through multiple vending machines which may be available. Other examples may include paying for network usage in a wireless hotspot, or even paying for photos and/or services at a photo kiosk. The concepts are readily extended to a variety of electronic devices and peripherals, as mentioned previously in this specification. A variety of advantages for electronic devices and peripherals having a first communication link and a second communication link have been noted herein. Additionally, it is apparent that a variety of other structurally and functionally equivalent modifications and substitutions may be made to implement and control embodiments of electronic devices and peripherals according to the concepts covered herein, depending upon the particular implementation, while still falling within the scope of the claims below.

We claim:

1. A system for sending a service request to a single peripheral among multiple peripherals, comprising:
a first communication link for identifying the multiple peripherals, and over which the service request will be sent to the single peripheral; and
a second communication link for identifying the single peripheral, wherein the range of the second communication link is less than the range of the first communication link.

2. The system of claim 1, wherein the first communication link is a radio frequency (RF) communication link.

3. The system of claim 1, wherein the RF communication link is selected from the group consisting of the IEEE 802.11 protocols and the Bluetooth protocol.

4. The system of claim 1, wherein the second communication link is a tactile communication link.

5. The system of claim 1, wherein the second communication link is an infrared (IR) communication link.

6. The system of claim 1, wherein the second communication link is an acoustic communication link.

7. An electronic device, comprising:
a first communication link;
a second communication link; and
a controller coupled to the first communication link and the second communication link, wherein the controller is configured to:
detect multiple peripherals on the first communication link;
detect a single peripheral on the second communication link; and
send a service request to the single peripheral over the first communication link.

8. The electronic device of claim 7, wherein the first communication link is a radio frequency (RF) communication link.

9. The electronic device of claim 7, wherein the second communication link is selected from the group consisting of a tactile communication link, an infrared (IR) communication link, and an acoustic communication link.

10. The electronic device of claim 7, wherein the second communication link is an acoustic communication link, comprising:
a sending transducer; and
a receiving transducer.

11. The electronic device of claim 7, wherein the second communication link is an acoustic communication link, comprising a sending and receiving transducer.

12. A peripheral, comprising:
a first communication link;
a second communication link; and
a controller coupled to the first communication link and the second communication link, wherein the controller is configured to transmit a unique identifier over the first communication link and the second communication link.

13. The peripheral of claim 12, wherein the first communication link is a radio frequency (RF) communication link.

14. The peripheral of claim 12, wherein the second communication link is selected from the group consisting of a tactile communication link, an infrared communication link, and an acoustic communication link.

15. The peripheral of claim 12, further comprising a connection to a network.

16. A method for an electronic device to select a single peripheral among multiple peripherals, comprising:
detecting the multiple peripherals on a first communication link;
detecting the single peripheral on a second communication link; and
sending a service request to the single peripheral over the first communication link.

17. The method of claim 16, wherein sending the service request to the single peripheral comprises:
rendering data on the electronic device;
sending the rendered data to the single peripheral over the first communication link; and
printing the rendered data with the single peripheral on a print media.

18. The method of claim 16, wherein sending the service request to the single peripheral comprises:
sending non-rendered data to the single peripheral over the first communication link;
rendering the non-rendered data to form rendered data on the single peripheral; and
printing the rendered data with the single peripheral on a print media.

19. The method of claim 16, wherein sending the service request to the single peripheral comprises:
sending a reference to data to the single peripheral over a first communication link;
retrieving the data based on the reference;
rendering the data if not already rendered; and
printing the rendered data with the single peripheral on a print media.

20. The method of claim 16, wherein the first communication link is a radio frequency (RF) communication link.

21. The method of claim 16, wherein the second communication link is selected from the group consisting of a tactile communication link, an infrared (IR) communication link, and an acoustic communication link.

22. The method of claim 16, wherein sending the service request to the single peripheral comprises sending information for a financial transaction.

23. The method of claim 22, wherein the financial transaction is selected from the group consisting of:
paying for a vending machine product;
paying for a purchase at a cash register;
paying for a purchase at an automated checkout stand;
interacting with an automated teller machine (ATM);
paying for fuel at a fueling station;
paying for a purchase at a photo kiosk;
paying for network usage in a hotspot area; and
paying for printed output on a print media.

24. A method for an electronic device to select a single peripheral among multiple peripherals, comprising:
detecting the multiple peripherals on a first communication link;
detecting the single peripheral on a second communication link; and
sending a service request to the single peripheral over the second communication link.

25. The method according to claim 24, wherein sending the service request to the single peripheral comprises:
sending a reference to data to the single peripheral over the second communication link;
retrieving the data from the reference;
rendering the data if not already rendered; and
printing the rendered data with the single peripheral on a print media.

26. The method according to claim 25, wherein the second communication link is an acoustic communication link.

27. A method for a first peripheral to avoid communication conflicts with a second peripheral, comprising:
monitoring an acoustic communication link for the presence of a second peripheral using a same acoustic wavelength; and
upon detecting a second peripheral using the same acoustic wavelength, changing the acoustic wavelength to a different acoustic wavelength.

28. The method of claim 27, wherein changing the acoustic wavelength comprises changing the acoustic wavelength to a randomly selected acoustic wavelength.

29. A method for an electronic device to avoid communication conflicts with multiple peripherals, comprising:
monitoring an acoustic communication link for the presence one or multiple peripherals;
after detecting a garbled acoustic communication signal, emitting an acoustic conflict signal indicating that there is an audio conflict; and
on the one or multiple peripherals which receive the acoustic conflict signal, changing the acoustic wavelength transmitted by the one or multiple peripherals.

30. A method for an electronic device to select a local peripheral among multiple peripherals, comprising:
detecting a global list of the multiple peripherals on a first communication link;
detecting a local list of at least two of the multiple peripherals on a second communication link;
selecting the local peripheral from the local list; and
sending a service request to the local peripheral over the first communication link.
